(19) United States
(12) Patent Application Publication
(10) Pub. No.: US 2023/0101808 A1
(43) Pub. Date: Mar. 30, 2023

(54) METHOD FOR PRODUCING AT LEAST ONE ELECTRODE FOR A BATTERY CELL

(71) Applicant: VOLKSWAGEN AKTIENGESELLSCHAFT, Wolfsburg (DE)

(72) Inventors: Mathias KRAKEN, Braunschweig (DE); Erik ROHKOHL, Wolfenbüttel (DE); Malte SCHÖNEMANN, Braunschweig (DE)

(73) Assignee: VOLKSWAGEN AKTIENGESELLSCHAFT, Wolfsburg (DE)

(21) Appl. No.: 17/800,804

(22) PCT Filed: Feb. 19, 2021
(86) PCT No.: PCT/EP2021/054142

§ 371 Date: Aug. 18, 2022

(30) Foreign Application Priority Data
Feb. 28, 2020 (DE) 10 2020 105 279.0

(51) Int. Cl. H01M 4/04; G06N 5/022

(52) U.S. Cl. CPC H01M 4/043; G06N 5/022

(57) ABSTRACT

The invention relates to a method for producing at least one electrode for a battery cell, the method comprising at least the following steps: a) providing a suspension for creating the at least one electrode, at least one target process parameter (1) being specifiable for providing the suspension; b) capturing at least one actual process parameter (2) while providing the suspension in step a); c) performing a prediction of at least one property (4) of the suspension by means of a machine-learned prediction algorithm (5), which estimates the at least one property (4) of the suspension depending on the at least one actual process parameter (2) and taking into account information on previously provided suspensions; d) defining at least one target process parameter (1) for providing the suspension in step a) depending on the prediction results from step c).

The invention relates to a method for producing at least one electrode for a battery cell, to a training method for a machine-learning-capable prediction algorithm, to a computer program for performing a corresponding method, and to a machine-readable storage medium on which a corresponding computer program is stored. The invention can be used in particular for (inline) quality prediction during the production of battery suspension for electrodes for lithium-ion batteries, for example.

This quality, for example describable by properties such as the viscosity and/or the particle size distribution of a battery suspension for the production of cathodes and/or anodes for lithium-ion battery cells, has a noticeable influence on the quality of the (end) product. In order to avoid cost-intensive rejects and/or to improve the understanding of the process, there is a need to create an option with which the most reliable information possible about the quality of the suspension produced and/or even the finished product produced with it can be obtained during the ongoing production process. In particular, there is an effort to allow an inline-capable prediction option in an extrusion process.

In this context, however, it has been found that a prediction option based on physical models is too imprecise, in particular due to the high complexity of the extrusion process and/or the large number of process parameters and possibly unknown disturbance variables. The most commonly used option so far has been the prediction made by a person skilled in the art. However, such predictions are shaped by the subjective feeling of each person and are therefore not reliable enough, either. In this context, it is also disadvantageous that an understanding of the process that has possibly been built up over years may no longer be available if the relevant person skilled in the art leaves the company.

U.S. Pat. Nos. 9,806,326 B2, 10,181,587 B2, and WO 2016/073438 A1 disclose various methods for producing at least one electrode for a battery cell. In particular, however, the known methods do not allow any prediction of the quality of the battery suspension.

Proceeding from this, it is an object of the invention to at least partially solve the problems described in connection with the prior art. In particular, a method for producing at least one electrode for a battery cell and a training method for a machine-learning-capable prediction algorithm are specified, which methods allow a mechanical, inline-capable, and as reliable as possible prediction of at least one property of the suspension for creating the electrode. In addition, the prediction should be able to be carried out with as little expenditure of time and/or as cost-effectively as possible.

These objects are achieved by the features of the independent claims. Further advantageous embodiments of the solution proposed herein are specified in the dependent claims. It should be pointed out that the features listed individually in the dependent claims can be combined with one another in any technologically reasonable manner and define further embodiments of the invention. In addition, the features specified in the claims are specified and explained in more detail in the description, in which further preferred embodiments of the invention are presented.

A method for producing at least one electrode for a battery cell contributes to this, the method comprising at least the following steps:
a) providing a suspension for creating the at least one electrode, at least one target process parameter being specifiable for providing the suspension;
b) capturing at least one actual process parameter while providing the suspension in step a);
c) performing a prediction of at least one property of the suspension by means of a machine-learned prediction algorithm, which estimates the at least one property of the suspension depending on the at least one actual process parameter and taking into account information on previously provided suspensions;
d) defining at least one target process parameter for providing the suspension in step a) depending on the prediction results from step c).

To perform the method, steps a) to d) can be performed, for example, at least once in the order specified. Furthermore, steps a) to d) can also be repeated (several times), or the method can start over repeatedly (in the manner of a loop) at step a). At least parts of steps a) to d), in particular of steps a) and/or b) and/or c), can be performed at least partially in parallel or simultaneously. The method can be performed using a prediction algorithm that has been trained using a training method that is also described herein.

The method advantageously allows for the mechanical, inline-capable, as reliably as possible prediction (usable in series production and in particular in the ongoing process) of at least one property of the suspension for creating the electrode. In addition, the mechanical prediction can be made with as little expenditure of time and/or as cost-effectively as possible. By using the machine-learned prediction algorithm, a large information content can advantageously be taken into account, which content can also take into account historical information about previously provided suspensions and/or information about preceding prediction results of the ongoing process. Furthermore, the method can contribute in a particularly advantageous manner to the inline-capable improvement of the (target) process parameters, for example by a validation using properties of the suspension measured during the ongoing process.

In step a), providing of a suspension takes place for creating the at least one electrode, at least one target process parameter being specifiable for providing the suspension. Said providing can take place, for example, by extruding the suspension. The at least one target process parameter can be set or specified, for example, via a human-machine interface of an extrusion plant or production plant. The at least one target process parameter can be, for example, one or more of the following parameters: dosing amount, screw speed of the extruder screw, and/or temperature in the extruder

In step b), capturing of at least one actual process parameter (and optionally at least one ambient condition) takes place during the provision in step a). Said capturing can take place, for example, by a sensory measurement. The at least one actual process parameter usually describes the actually achieved value of the target process parameter. The at least one ambient condition can be, for example, one or more of the following conditions: ambient temperature, ambient pressure, (air) humidity, and/or time of day.

Furthermore, at least one target process parameter and/or at least one raw material property of the raw material used to provide the suspension can also be captured in step b). In particular in step b), information about preceding prediction results of the ongoing process can also be captured. Measured properties of the suspension can also be captured (measured) or read in in step b) (for validation purposes).

In step c), performing of a prediction of at least one property of the suspension by means of a machine-learned prediction algorithm takes place, which estimates the at least one property of the suspension depending on the at least one actual process parameter (and possibly the at least one ambient condition) and taking into account information on previously provided suspensions. The at least one property of the suspension estimated by means of the prediction algorithm can be, for example, one or more of the following properties: viscosity, density, shear rate, and/or homogeneity.

If the corresponding information has been captured, provision can also be made for the prediction algorithm to (additionally) estimate the at least one property of the suspension depending on one or more of the following items of information: at least one target process parameter, at least one raw material property of the raw material used to provide the suspension, and/or at least one item of information about prediction results of the ongoing process that precede in time.

The information about previously provided suspensions can in particular have been learned during an (initial) training phase. The information learned in particular during the (initial) training phase can be represented, for example, by appropriate configurations (or adaptations) and/or linkages of elements of the algorithm. The elements can be, for example, model parameters of the algorithm, such as weights, functions, threshold values, or the like. The algorithm can be implemented by an (artificial intelligence, or AI) model, and/or in an (AI) model. The algorithm can furthermore also comprise a number of parts or partial algorithms which, for example, can interact with one another next to one another on one level, and/or on a plurality of levels one above the other, and/or in a plurality of time steps one after the other.

For example, the algorithm can be set up in such a way that it maps a set of input data to at least one output or a set of output data. Input data of the algorithm are usually the at least one (time-variant or time-dependent) actual process parameter and optionally the at least one (time-variant or time-dependent) ambient condition. Optionally, the input data can also contain at least one (time-variant or time-dependent) target process parameter, and/or at least one (possibly time-invariant or time-independent) raw material property, and/or at least one item of information about previously provided suspensions, and/or information about a previous time step, in particular a temporally preceding prediction result of the algorithm and/or properties of the suspension measured for validation purposes. The at least one output generally comprises the prediction result, i.e., the at least one (predicted and in particular time-variant or time-dependent) property and/or at least one (predicted) final property of the suspension. In particular, during the ongoing process (i.e., while providing, for example, the extrusion of the suspension) in, for example, fixed time intervals and/or at at least one specific (future or following) point in time, a machine prediction of at least one property of the (just provided) suspension and/or possibly even the finished suspension can be made (e.g., as a prognosis of the final properties that are set when the ongoing process is completed, or the possibly existing container is filled to a predeterminable degree of filling and/or the suspension has cooled down). In other words, this can also be described in such a way that the prediction can also take place in such a way that at least one property of the finished suspension or at least one (discrete) product property can be estimated at the final point in time. In particular, the prediction can (therefore) take place depending on the process time. For example, the prediction can be made for the (immediately) following time step and/or for all time steps up to the end of the process. If a set of output data is output, for example different (physical) properties of the suspension, such as a viscosity and a shear rate of the suspension, can be output. By way of example, sets of data may be provided in the form of vectors, such as at least one input vector and at least one output vector.

The prediction algorithm can be formed, for example, in the manner of a so-called machine learning model. For example, the prediction algorithm can comprise modeling of the production process by means of what is known as a gated recurrent unit.

Alternatively or cumulatively, the prediction algorithm can comprise modeling of the process by means of what is known as a multi-layer perceptron. A feature vector or input vector can contain, for example, all time-variant (input) signals up to a specific point in time. If this point in time is reached during the process, the result of future measurements can be predicted (once).

In step d), defining of at least one target process parameter takes place for providing the suspension in step a) depending on the prediction results from step c). In principle, the defining can take place manually, for example by a person responsible for the process. Defining can advantageously take place automatically, for example by a process controller which can access and/or comprise the prediction algorithm. In particular, at least one target process parameter can be adjusted or changed if the prediction result results in a violation of tolerance limits.

According to one advantageous embodiment, it is proposed that the method is performed for producing at least one anode or cathode for a lithium-ion cell. In this context, the suspension may, for example, comprise one or more of the following raw materials: storage time, particle size distribution, and storage conditions (e.g., temperature and humidity).

According to a further advantageous embodiment, it is proposed for the suspension to be provided by extruding the suspension into a container. For example, the container can have an inner shape that corresponds to the outer shape of the electrode to be produced. Alternatively, the container can also only be used for transport to a downstream production step (film coating). The provision can be made, for example, until a predeterminable degree of filling of the container is reached. The final property of the suspension usually occurs when or after the predeterminable degree of filling of the container has been reached. If the final property occurs after the predeterminable degree of filling has been reached, this applies in particular to the property after a (pre)definable cooling process.

According to a further advantageous embodiment, it is proposed that the machine-learned prediction algorithm is formed by means of an artificial neural network. As a rule, the network contains elements or model parameters by means of which the input data can be mapped to the output data. Corresponding elements or model parameters can comprise, for example, nodes, weights, links, threshold values, or the like. A so-called recurrent neural network can be mentioned herein as an example of the artificial neural network.

According to a further advantageous embodiment, it is proposed that the machine-learned prediction algorithm be formed by means of a long short-term memory network (abbreviated as LSTM network, or LSTM). The basic structure of such a network is known from other fields of application, in particular from the field of natural language processing, so that this is not discussed in detail herein, either. In particular, the LSTM network can map an algorithm based on time series. The LSTM network is preferred over alternative algorithms in particular because of the following advantages: The LSTM network can advantageously model time-variant (longer) signals better than gated recurrent units or recurrent neural networks, in particular because an improvement by means of a gradient descent method can converge faster in this case. A multi-layer perceptron usually has no information about previous inputs and outputs compared to the LSTM network. Furthermore, the LSTM network allows a time-variant modeling of continuous process parameters, ambient conditions, and time-invariant material properties in a particularly advantageous manner (and in relation to the described application).

According to a further advantageous embodiment, it is proposed that at least one property of the suspension is measured in order to validate a prediction that has been performed. Furthermore, the measured (time-variant or time-dependent) property of the suspension can be used to further train or improve the prediction algorithm (“inline”, i.e., during its regular operation or the ongoing process).

According to a further aspect, a training method for a machine-learning-capable prediction algorithm is proposed, the method comprising at least the following steps:
i) reading in training input data for the prediction algorithm, which comprise actual process parameters and optionally ambient conditions of a large number of provision processes for providing a suspension for creating an electrode for a battery cell;
ii) reading in training output data for the prediction algorithm, which comprise properties of the suspension provided by means of the corresponding provision process;
iii) adapting elements, preferably weightings, of the prediction algorithm in order to map the training input data that has been read in as precisely as possible to the training output data that has been read in.

To perform the method, steps i) to iii) can be performed, for example, at least once in the order specified. Furthermore, steps i) to iii) can also be repeated (several times), or the method can start repeatedly (in the manner of a loop) with step i). At least parts of steps i) and ii) can be performed at least partially in parallel or simultaneously. The method can be performed for machine learning of a prediction algorithm that is also described herein.

According to an advantageous embodiment, it is proposed that a gradient descent method be used or performed to adapt elements of the prediction algorithm. For example, during the training by means of the gradient descent method, elements or model parameters of the algorithm are adjusted until a prediction error across all training examples is minimal.

According to a further aspect, a computer program for performing a method described herein is also proposed. In other words, this relates in particular to a computer program (product), comprising instructions which, when the program is executed by a computer, cause the latter to execute a method described herein.

According to a further aspect, a machine-readable storage medium is also proposed, on which the computer program is stored. The machine-readable storage medium is usually a computer-readable data carrier.

Furthermore, a production plant for producing at least one electrode for a battery cell can be specified, which is provided and configured for performing a method described herein. For this purpose, the production plant can comprise, for example, a controllable extruder, a (possibly controllable) raw material feed, sensors for capturing at least some of the input data described above, and/or a container into which the suspension can be extruded. In particular, the production plant comprises a control device on which an (electronic or digital) controller for performing a method described herein is implemented. The control device can, for example, comprise a computing unit (controller) that can access the storage medium and/or execute the computer program in order to perform a method described herein. The storage medium and/or the computer program can also be a component of the control device or can be connected thereto using signals.

The details, features, and advantageous embodiments discussed in connection with the method for production can accordingly also occur in the training method, the computer program, the storage medium, and/or the production plant described herein, and vice versa. In this respect, full reference is made to those embodiments for a more detailed characterization of the features.

The solution presented herein and its technical field are explained in more detail below with reference to the drawings. It should be pointed out that the invention is not intended to be limited by the embodiments shown. In particular, unless explicitly stated otherwise, it is also possible to extract partial aspects of the facts explained in or in connection with the drawings and to combine them with other components, and/or findings from other drawings, and/or the present description. Schematically, in the drawings:

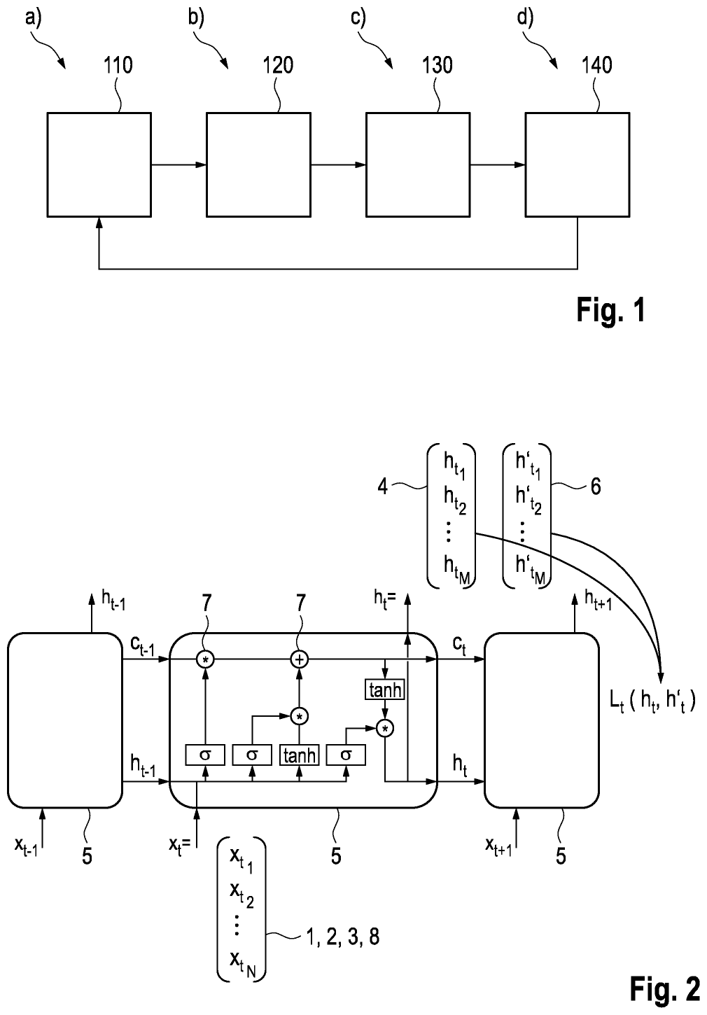

FIG. 1: shows a flowchart to illustrate an embodiment of the method described herein;

FIG. 2: shows an illustration of an embodiment of the prediction algorithm described herein;

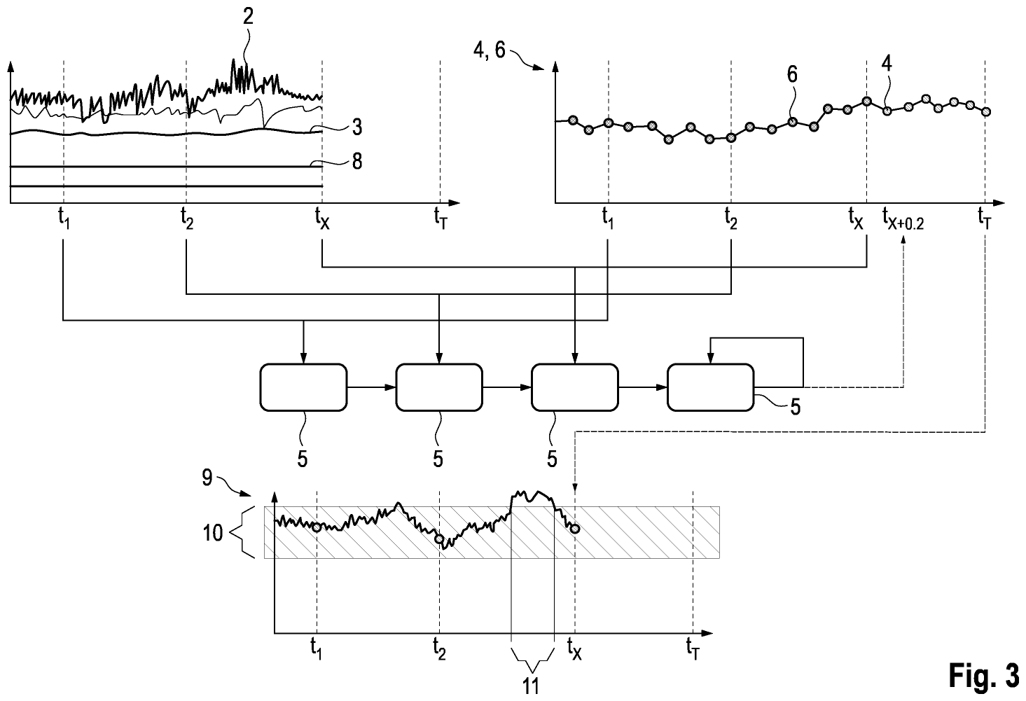

FIG. 3: shows an illustration of possible prediction results of the prediction algorithm; and

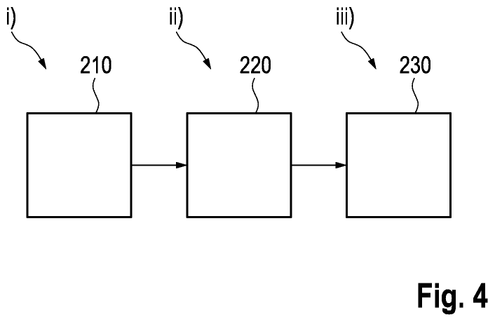

FIG. 4: shows a flowchart to illustrate an embodiment of the training method described herein.

FIG. 1 schematically shows a flowchart to illustrate an embodiment of the method described herein for the production of at least one electrode for a battery cell. The sequence of steps a), b), c), and d) represented by blocks 110, 120, 130, and 140 is an example and can thus occur, for example, in a regular sequence of the method.

In block 110 and according to step a), providing of a suspension takes place for creating the at least one electrode, at least one target process parameter 1 being specifiable for providing the suspension. In block 120 and according to step b), capturing of at least one actual process parameter 2 and, for example, at least one ambient condition 3 takes place during the provision in step a). In block 130 and according to step c), performing of a prediction of at least one property 4 of the suspension by means of a machine-learned prediction algorithm 5 takes place, which estimates the at least one property 4 of the suspension depending on the at least one actual process parameter 2 and, for example, on the at least one ambient condition 3, and taking into account information on previously provided suspensions. In block 140 and according to step d), defining of at least one target process parameter 1 takes place for providing the suspension in step a) depending on the prediction results from step c).

The method can be performed, for example, for producing at least one anode or cathode for a lithium-ion cell. In this context, provision can also be made for the suspension to be provided by extruding the suspension into a container. The extruder usually produces battery suspension continuously. During the extrusion, a machine prediction of, for example, property 4 of the suspension just introduced into the container and/or possibly even of the finished suspension can be made in fixed time intervals (e.g., as a forecast of the properties that are set when the container is filled to a predeterminable degree of filling and/or the suspension has cooled down). In particular, the method can even allow a prediction of the properties 4 that is as accurate as possible, which prediction is or will be expected to result in the battery suspension at the end of the extrusion process (i.e, when the container is filled to a predeterminable degree of filling and/or the suspension has cooled down). In a particularly advantageous manner, this allows for an (inline) adjustment of the target process parameters during the still ongoing extrusion process if the predicted properties 4 do not correspond to the desired or specifiable target values.

FIG. 2 schematically shows an illustration of an embodiment of the prediction algorithm described herein. The reference signs are used consistently so that reference can be made to the previous explanations.

The machine-learned prediction algorithm 5 can be formed by means of an artificial neural network, for example. In this context, FIG. 2 shows, by way of example, a prediction algorithm that is formed by means of a Long Short-Term Memory network (abbreviated as LSTM network). The variables “x” show the input data or the input vector, the variables “h” show the (possibly hidden) output data or the (possibly hidden) output vector, the variables “c” show the cell states of the LSTM network, the subscripts “t−1,” “t,” “t+1,” etc. show different time steps, the subscripts “1 . . . N” show the different input data at a corresponding point in time, the subscripts “1 . . . M” show the different output data at a corresponding point in time.

As an example, the course of the input data “x” is mapped by time-variant signals. The input data “x” comprise in this context at the corresponding point in time the actual process parameters 2, possibly the ambient conditions 3, and possibly also the (already specified) target process parameters 1, and/or possibly also known raw material properties 8. In the embodiment shown, modeling by means of a Long Short-Term Memory (LSTM) network describes the relationship between the input data mentioned and the output data “h.” In this context, the output data “h” comprised the predicted properties 4 of the battery suspension (depending on the process time) at the corresponding point in time. In other words, this can also be described in such a way that a feature vector “x” that contains all (actual) process parameters and possibly ambient conditions at a discrete point in time is given as an input vector in the LSTM network. The LSTM network is set up to approximate the properties 4 of the battery suspension, i.e., the target vector, at this point in time.

During production, the quality of the suspension or the (actual) property 6 of the suspension (for comparison with the predicted property 4) can optionally and additionally be measured manually, for example at fixed time intervals, in particular until the container is filled up to the predeterminable degree of filling (or is filled completely). These manually measured properties 6 can contribute advantageously to validating the forecasts of the prediction algorithm 5. These properties 6 are described in FIG. 2 with the variable “h′.” This represents an example of the fact that, and possibly how, the at least one property 6 of the suspension can be measured in order to validate a prediction that has been performed.

If the measured properties 6 are also present, an error “L” can be determined, which can be used (inline or after the actual or initial training) to further train or improve the prediction algorithm. For example, the LSTM network can be implemented over time in this context. Furthermore, prediction errors “L” and gradients can be calculated for each time step. In addition, the gradients can be averaged over all time steps. Elements 7 of the algorithm 5 can then be adapted on this basis. Alternatively or cumulatively, a so-called Truncated Backpropagation Through Time method (abbreviated as TBPTT method) can also be used to improve the (already initially trained) network.

FIG. 3 schematically shows an illustration of possible prediction results of the prediction algorithm 5. The reference signs are used consistently so that reference can be made to the previous explanations.

It can be seen in particular that a time-variant modeling of (continuous) process parameters 2, possibly ambient conditions 3 and possibly time-invariant (raw) material properties 8, can take place using an algorithm 5 in the form of a Long Short-Term Memory network.

FIG. 3, at the top left, shows an example of input data 2, 3, 8, and FIG. 3, at the top right, shows an example of an illustration of output data 4 of the algorithm 5. It can be seen that the individual time steps are represented by successive cells of the algorithm 5. The algorithm 5 can generally input data 2, 3, 8 at a corresponding time step—for example comprising actual process parameters 2, ambient conditions 3, and possibly raw material properties 8 (and possibly also target process parameters 1, cf. FIG. 2)—as well as historical data or information about previously provided suspensions. The historical data or information about previously provided suspensions generally comprises at least such information that was learned during the training phase from the training data records which are usually based on historical data or information about previously provided suspensions. This information learned during the (initial) training phase can be represented, for example, by appropriate configurations and/or linkages of the elements 7 of the algorithm 5.

FIG. 3 also shows that the historical data or information about previously provided suspensions can also comprise information from a(n) (immediately) preceding time step of the algorithm 5 (in this case, for example, an upstream cell of the network). In addition, measured, actual properties 6 of the suspension, in particular for validation purposes, can flow into the algorithm 5 as an input. These properties 6 can also contribute to further training and/or improving the algorithm 5 (“inline”, i.e., during its regular operation or the ongoing process).

FIG. 3 also shows that the prediction can be made not only for a specific point in time in the future (in this case t_x+0.2, for example), but possibly also for a large number of points in time in the future, which may possibly be validated over time by the properties 6. In this way, for example, (continuous) product properties 4 can be estimated at the corresponding point in time t. In particular (as an alternative or cumulatively to a prediction of a large number of future points in time), a prediction can also be made for a final point in time (herein “T,” by way of example). In other words, this can also be described in such a way that the prediction can also take place in such a way that it estimates at least one property 4 of the finished suspension or at least one (discrete) product property 4 at the final point in time T.

This at least one property 4 of the finished suspension can also be referred to herein as at least one “final” property 9 (symbol T) and can be monitored, for example, according to the illustration at the bottom in FIG. 3. The final property 9 of the suspension predicted at the respective points in time or time steps during the process is plotted herein over time. From this illustration, it can be determined, for example, whether the prediction of the final property 9 of the suspension during the process remains or has remained within a tolerance band 10 or possibly for what period(s) 11 this property 9 is or was outside of the tolerance band 10. For example, it can be provided that, for example, the target process parameters are adjusted by a person responsible for the process or are automatically adjusted depending on the prediction and/or a resulting error if the prediction results in a violation of tolerance limits.

FIG. 4 shows a schematic flowchart to illustrate an embodiment of the training method described herein for a machine-learning-capable prediction algorithm 5 (cf. FIGS. 2 and 3). The reference signs are used consistently so that reference can be made to the previous explanations. The sequence of steps i), ii), and iii) represented by blocks 210, 220, and 230 is an example and can thus occur, for example, in a regular sequence of the method.

In block 210 and according to step i), reading in of training input data for the prediction algorithm 5 takes place, which comprise actual process parameters 2 and optionally ambient conditions 3 of a large number of provision processes for providing a suspension for creating an electrode for a battery cell. In block 220 and according to step ii), reading in of training output data for the prediction algorithm 5 takes place, which comprise properties 6 of the suspension provided by means of the corresponding provision process. In block 230 and according to step iii), adapting of elements 7 of the prediction algorithm 5 takes place, in order to map the training input data that has been read in as precisely as possible to the training output data that has been read in. For example, a gradient descent method can be used to adapt elements 7 of the prediction algorithm 5.

With the help of artificial intelligence (AI) methods, it is advantageously possible to predict the results of future measurements on the basis of a data set of historical (extrusion) processes and measurement(s) of the battery suspension, preferably at a large number of points in time or, if possible, at any point in time of the (corresponding) process. In this context, it is particularly advantageous to record process parameters 1, 2, ambient conditions 3, and raw material properties 8 and to continue to record them in a traceable manner. This database can serve as an example training set for the (AI) algorithm 5.

During the training, the algorithm 5 (in this case the LSTM network, as an example) is presented with a large number of training examples, usually consisting of a feature vector and a target vector. Furthermore, randomly initialized model parameters (shown herein by way of example by elements 7) of the LSTM network can ensure an inaccurate prediction at the beginning of the training. During the training, the model parameters can be adjusted by means of the gradient descent method, for example, until the prediction error is minimal across all training examples.

After training the model or algorithm for predicting the quality of the battery suspension, it can be used to make predictions for unknown combinations of process parameters 1, 2, possibly ambient conditions 3 and possibly material properties 8 during the (current) process. The additional measurement of suspension properties 6 can help validate the predictions and/or improve prediction accuracy at later points in time. Due to the statistical significance of large amounts of data, the prediction of the algorithm 5 is advantageously more accurate than that of a person skilled in the art and of physical models.

A method for producing at least one electrode for a battery cell and a training method for a machine-learning-capable prediction algorithm are thus specified, which methods at least partially solve the problems described in connection with the prior art. In particular, a method for producing at least one electrode for a battery cell and a training method for a machine-learning-capable prediction algorithm are specified, which methods allow a mechanical, inline-capable, and as reliable as possible prediction of at least one property of the suspension for creating the electrode. In addition, the prediction can be made with as little expenditure of time and/or as cost-effectively as possible.

### LIST OF REFERENCE SIGNS

1 Target process parameters
2 Actual process parameters
3 Ambient condition
4 Property
5 Prediction algorithm
6 Property
7 Element
8 Raw material properties
9 Property
10 Tolerance band
11 Time window

1. A method for producing at least one electrode for a battery cell, the method comprising at least the following steps:
a) providing a suspension for creating the at least one electrode, at least one target process parameter being specifiable for providing the suspension;
b) capturing at least one actual process parameter while providing the suspension in step a);
c) performing a prediction of at least one property of the suspension by means of a machine-learned prediction algorithm, which estimates the at least one property of the suspension depending on the at least one actual process parameter and taking into account information on previously provided suspensions;
d) defining at least one target process parameter for providing the suspension in step a) depending on the prediction results from step c).

2. The method according to claim 1, wherein the method is performed for producing at least one anode or cathode for a lithium-ion cell.

3. The method according to claim 1, wherein the step of providing the suspension takes place by extruding the suspension into a container.

4. The method according to claim 1, wherein the machine-learned prediction algorithm is formed by means of an artificial neural network.

5. The method according to claim 1, wherein the machine-learned prediction algorithm is formed by means of a long short-term memory network.

6. The method according to claim 1, wherein at least one property of the suspension is measured in order to validate a prediction that has been performed.

7. A training method for a machine-learning-capable prediction algorithm, the method comprising at least the following steps:
i) reading in training input data for the prediction algorithm, which comprise actual process parameters of a large number of provision processes for providing a suspension for creating an electrode for a battery cell;
ii) reading in training output data for the prediction algorithm, which comprise properties of the suspension provided by means of the corresponding provision process; and
iii) adapting elements of the prediction algorithm in order to map the training input data that have been read in as precisely as possible to the training output data that have been read in.

8. The training method according to claim 7, wherein a gradient descent method is used to adapt elements of the prediction algorithm.

9. A computer program for performing a method according to claim 7.

10. A machine-readable storage medium on which the computer program according to claim 9 is stored.

11. A computer program for performing a method according to claim 1.

12. A machine-readable storage medium on which the computer program according to claim 11 is stored.
